(19) United States
(12) Patent Application Publication
(10) Pub. No.: US 2022/0395923 A1
(43) Pub. Date: Dec. 15, 2022

(54) WELDING METHOD AND WELDING DEVICE FOR WELDING CONDUCTOR ENDS

(71) Applicant: GROB-WERKE GmbH & Co. KG, Mindelheim (DE)

(72) Inventors: Konstantin HOFMANN, Mindelheim (DE); René SCHÜRER, Mering (DE)

(21) Appl. No.: 17/835,195

(22) Filed: Jun. 8, 2022

(30) Foreign Application Priority Data
Jun. 14, 2021 (EP) 21179299.9

(51) Int. Cl. B23K 26/03; B23K 9/095

(52) U.S. Cl. CPC B23K 26/032; B23K 9/0956; B23K 2101/38

(57) ABSTRACT

A welding method for welding grouped conductor ends of a component for an electrical machine by means of a welding device. In the method, a relative position of a first conductor end and a second conductor end of grouped conductor ends and then a first size parameter of a molten pool formed during welding are detected. Subsequently, a second size parameter of the molten pool formed during welding is detected. In a further method step, a value of the molten pool is determined from the first size parameter, the second size parameter and the relative position. Finally, a welding energy input is controlled depending on the determined value of the molten pool.

### CROSS-REFERENCES TO RELATED APPLICATIONS

This application claims the benefit of the European patent application No. 21179299.9 filed on Jun. 14, 2021, the entire disclosures of which are incorporated herein by way of reference.

### FIELD OF THE INVENTION

The invention relates to a welding method for welding grouped conductor ends of a component for an electrical machine by means of a welding device. Further, the invention relates to a welding device for welding grouped conductor ends of a component for an electrical machine, the welding device comprising welding means for applying welding energy to grouped conductor ends. In particular, the invention relates to a method and a device for welding grouped conductor ends, i.e., conductor end groups, in particular pairs of conductor ends (hereinafter also referred to as pin pairs), of a component for an electrical machine, in particular a stator of an electric motor configured as a drive motor for an electric vehicle.

### BACKGROUND OF THE INVENTION

Electrical machines are understood to mean, in particular, machines for converting electrical energy into kinetic energy and/or machines for converting kinetic energy into electrical energy. In particular, these are understood to mean electric motors and generators.

In the manufacture of components of such electrical machines, such as stators or rotors, it is often necessary to process ends of conductors formed from wires together, such as cutting or forming them together, and to connect them with each other.

In a component of an electrical machine, coil windings can thus be formed by welding pairs of conductor ends. Contacting thus takes place via a substance-to-substance bond, which can be realized using various welding processes. In addition to various beam welding processes, such as laser beam or electron beam welding, arc-based processes, such as TIG and plasma welding, are also well-established in the prior art. The conductor ends to be contacted are welded in a butt joint at their free ends, with the geometry of the weld joint forming a bead-shaped or hemispherical contour. Depending on the required mechanical and electrical properties, the connection cross-section is set individually via the fusion volume or the bead height. The term “connection cross section” refers, in particular, to a material bond between the joining partners in the parallel plane of the joint.

In the welding process itself, energy is applied two-dimensionally so that the end face of the conductor ends is completely melted and a closed fusion blanket is produced as a result. In laser beam welding, the energy is introduced along a predetermined or characteristic welding contour whose geometry and dimension are selected as a function of the wire cross section. The dimension of these contours extends over the entire cross section of the pair of conductor ends or the conductor ends to be welded, so that a constant and uniform fusion blanket is produced. Depending on the required connection cross-section, a predetermined or characteristic fusion volume is required. In particular, this requires repetition of the welding contour until the required connection cross-section is achieved.

State of the art for analyzing the welding depth is the measurement of the keyhole depth. For this preferred application, the following literature:

[1] Hollatz, S.; Processing of keyhole depth measurement data during Laser Beam Micro welding; In: Journal of Materials; Design and applications;

to which explicit reference is made for further details, describes an analysis of the welding depth.

Any such coil winding will only work if all its welded joints are technically sound. For example, functionality of a stator is given only if all the welded joints of all its coil windings are technically in order. Since stators for the above-mentioned purposes usually comprise more than 200 pairs of conductor ends, this results in a high demand on the weld quality, since even a single joint that is not in order is sufficient for the entire stator to be a reject.

### SUMMARY OF THE INVENTION

It is an object of the invention to provide for a universally applicable and/or particularly reliable production of electrical connections by a welding operation on components of an electrical machine to be produced especially in large series.

Advantageous embodiments are the subject of the subclaims.

According to one aspect thereof, the invention provides a welding method for welding grouped conductor ends of a component for an electrical machine by means of a welding device, comprising the step of:

detecting a relative position of a first conductor end and a second conductor end of grouped conductor ends by position measurement using optical measurement methods, and then the steps of:

a) detecting a first size parameter of a molten pool produced during welding;

b) detecting a second size parameter of the molten pool formed during welding;

c) determining a value of the molten pool from the first size parameter, the second size parameter, and the relative position; and

d) controlling a welding energy input depending on the determined value of the molten pool.

By “conductor ends” are meant, in particular, end regions or ends of conductors or pins. By “grouped” is meant, in particular, that two or more conductor ends are arranged or formed in a predetermined arrangement with respect to each other. By “detecting” is meant, in particular, a measurement or a determination or a registration. By “size parameter” is meant, in particular, an identifying or characterizing size or variable or a parameter. By “determine” is meant, in particular, a calculation or a measurement. By “welding energy input” is meant, in particular, a predetermined welding energy a welding beam has. Preferably, process steps a) to d) are performed in-line, i.e., during the welding process.

It is preferred that step a) comprises the step of:

a1) detecting the first size parameter by means of optical measurement methods.

It is preferred that step a) comprises the step of:

a2) detecting the first size parameter by means of time-of-flight measurement of reflected radiation. By “radiation” is meant, in particular, a measuring beam or a measuring radiation. Other measurement methods based on time-of-flight measurements can also be used. Generally, any measurement principle with which different dimensions of the welding zone can be geometrically measured is suitable.

It is preferred that step a) comprises the step of:

a3) performing an optical coherence tomography. Optical coherence tomography is, in particular, an imaging method. Preferably, optical coherence tomography involves taking or obtaining 2- and 3-dimensional images. The images are, in particular, in a very low resolution, preferably micrometer resolution. In optical coherence tomography, in particular, broadband light of temporally small coherence length is split into two parts in a beam splitter. One part is directed onto a sample or workpiece or component. The other part passes through a reference path. The light reflected from the sample or component, for example the conductor ends, is superimposed with the reference light in an interferometer and thus caused to interfere. Different structures along an optical axis or depth can then be distinguished from the interference signal. By scanning laterally across the sample or component, three-dimensional images or pictures can be obtained. Optical coherence tomography can preferably be used to measure a change in process zone dimension during a welding process.

It is preferred that step a) comprises the step of:

a4) arranging a double cross relative to the grouped conductor ends, in particular relative to an end region of the grouped conductor ends, and arranging lines of the double cross relative to each other, in particular at a predetermined distance from each other. The double cross may also be referred to as a hashtag. In particular, the double cross is arranged in a plane relative to the end region. In other words, the double cross may be in a plane with the end region or the end surfaces of the conductor ends. In other words, the double cross may be placed or projected on the end region of the grouped conductor ends. Preferably, the double cross has four lines or measuring lines or dimension lines, two of which are arranged parallel to each other at a predetermined distance, and the respective pair of lines of which the two lines are parallel to each other is perpendicular to or arranged perpendicular to the other pair of lines, that is, the two pairs of lines are arranged or set up in a cross to each other.

It is preferred that step a) comprises the step of:

a5) forming a double cross, which is associated, in particular, with an end region of the grouped conductor ends, larger than a welding contour. A “welding contour” is formed, in particular, by traveling along the component, in particular the end region of the grouped conductor ends, with the welding beam, preferably along a predetermined contour or mask.

It is preferred that step a) comprises the step of:

a6) forming a double cross in such a way that a measuring beam, which can be guided along the lines of the double cross, has predetermined jump paths and/or jump times. In other words, a measuring beam can be guided along the lines of the double cross or can travel along the lines. Depending on the arrangement, i.e., the distance of the lines from each other, the measuring beam can have predetermined jump paths and/or jump times when traveling, in particular from one line to the next. By “measuring beam” is meant in particular a radiation, for example light, which has a predetermined wavelength.

It is preferred that step a) comprises the step of:

a7) directing, in particular alternately directing, a measuring beam to different conductor ends. In other words, a measuring beam can be guided or directed to predetermined conductor ends or end regions of the conductor ends. Thereby, the measuring beam can be guided from one conductor end to the next conductor end and back.

It is preferred that step a) comprises the step of:

a8) directing a measuring beam onto the grouped conductor ends in at least two dimensions. Preferably, the measuring beam is moved in an x-direction and a y-direction. In particular, the measuring beam can be guided in a plane. Preferably, the x-direction and the y-direction extend parallel to a plane of an end portion of the conductor ends or an end face or a cross-sectional area of the conductor ends. In particular, the plane defined by the x- and y-directions extends parallel to the conductor ends or to a plane of an end region of the conductor ends or an end face or a cross-sectional area of the conductor ends.

It is preferred that step a) comprises the step of:

a9) directing a measuring beam to a first conductor end of the grouped conductor ends, in particular a first end region of the first conductor end, and to a second conductor end of the grouped conductor ends, in particular a second end region of the second conductor end, in at least two dimensions.

It is preferred that step a) comprises the step of:

a10) scanning a measuring beam along a double cross that is assigned to the grouped conductor ends, the double cross comprising two lines respectively arranged in the x- and y-directions, which are arranged, in particular, at a predetermined distance from one another. The x-direction and the y-direction extend, in particular, perpendicularly to a main extension direction of the conductors. The x-direction and the y-direction extend, in particular, parallel to a cross-sectional plane of the conductor ends.

It is preferred that step a) comprises the step of:

a11) detecting an extension, in particular a lateral extension, of the molten pool as a first size parameter, in particular in a plane of the grouped conductor ends. In other words, an extension of the molten pool in an x-direction and a y-direction can be detected. In other words, an area occupied by the molten pool can be detected.

It is preferred that step a) comprises the step of:

a12) detecting at least one input parameter, wherein as the at least one input parameter a cross-sectional area of an end region of the grouped conductor ends or at least one conductor end and/or a distance between the conductor ends, in particular before welding, and/or a height offset between the conductor ends and/or a radial offset and/or a tangential offset, is detected. In particular, the at least one input parameter is detected for determining the value. In other words, input parameters may be considered for determining the value. By determining one or more input parameters, an initial situation or a position of the conductor ends before welding can be detected.

It is preferred that step b) comprises the step of:

b1) detecting the second size parameter using optical measurement techniques.

It is preferred that step b) comprises the step of:

b2) detecting the second size parameter by means of time-of-flight measurement of reflected radiation. Other measurement methods based on time-of-flight measurements can also be used. Generally, any measurement principle that can be used to geometrically measure different dimensions of the welding zone is suitable.

It is preferred that step b) comprises the step of:

b3) performing optical coherence tomography.

It is preferred that step b) comprises the step of:

b4) detecting the second size parameter at a position of a welding beam.

In other words, the second size parameter can be detected at a current position where the welding beam meets the grouped conductor ends. Particularly preferably, the second size parameter can be detected at a position of a focal spot of the welding beam, particularly preferably a laser spot of the laser beam as the welding beam.

It is preferred that step b) comprises the step of:

b5) guiding or directing a measuring beam to a position, in particular a current position, of a welding beam. Particularly preferably, the measuring beam can follow the welding beam.

It is preferred that step b) comprises the step:

b6) detecting a depth of a hole or a vapor capillary or a vapor channel, in particular a keyhole, at a position of a welding beam. By “keyhole” is meant in particular a vapor channel due to phase transformation in the focal spot of the welding beam, in particular laser beam.

It is preferred that step b) comprises the step of:

b7) detecting a depth of a hole or a vapor capillary or a vapor channel, in particular a keyhole, at a position of a welding beam in a main extension direction of the grouped conductor ends.

It is preferred that step b) comprises the step of:

b8) detecting a depth of a hole or a vapor capillary or a vapor channel, in particular a keyhole, in a beam direction of a welding beam.

It is preferred that step b) comprises the step of:

b9) detecting a gap depth during gap crossing of a measuring beam and/or welding beam. By “gap” is meant, in particular, a gap between the conductor ends. In particular, the conductor ends are arranged at a predetermined distance from each other, whereby the gap is formed. By “gap crossing” is meant, in particular, a movement of the measuring beam and/or welding beam from one conductor end to the next conductor end, in particular across the gap.

It is preferred that step b) comprises the step:

b10) detecting a molten pool depth. By “molten pool depth” is meant, in particular, an extension of the molten pool in a main extension direction, i.e., preferably in a z-direction, of the conductors.

It is preferred that step b) comprises the step of:

b11) detecting a molten pool depth on a surface of at least one conductor end or the grouped conductor ends, in particular at an end region of the grouped conductor ends. In other words, in particular, it is possible to detect or determine how far the molten pool extends in the main extension direction starting from the surface of at least one conductor end or the grouped conductor ends. In other words, a height of the molten pool on a surface of at least one conductor end or the grouped conductor ends can be detected.

It is preferred that step b) comprises the step of:

b12) detecting a welding depth at a position of a welding beam.

It is preferred that step b) comprises the step of:

b13) correlating a detected depth, in particular keyhole depth, at a position of a welding beam with height information in a main extension direction of the grouped conductor ends. In other words, the detected depth can be related to a height of the molten pool as a second size parameter.

It is preferred that step b) comprises the step of:

b14) detecting at least one input parameter, wherein as the at least one input parameter a cross-sectional area of an end portion of the grouped conductor ends or at least one conductor end and/or a distance between the conductor ends, in particular before welding, and/or a height offset between the conductor ends and/or a radial offset and/or a tangential offset is detected. In particular, the at least one input parameter is detected for determining the value. In other words, input parameters may be considered for determining the value. By determining one or more input parameters, an initial situation or a position of the conductor ends prior to welding can be detected.

It is preferred that step c) comprises the step of:

c1) determining a molten pool dimension of the molten pool as a value of the molten pool. In particular, the molten pool dimension may be determined or detected by an extension of the molten pool in the x- and y-directions and/or the keyhole depth.

It is preferred that step c) comprises the step of:

c2) determining an increase in a melt volume as a value of the molten pool.

It is preferred that step c) comprises the step of:

c3) determining a connection cross-section of the grouped conductor ends as a value of the molten pool. Particularly preferably, the connection cross-section can be determined by determining the molten pool dimension.

It is preferred that step d) comprises the step of:

d1) directing a welding beam to the grouped conductor ends.

It is preferred that step d) comprises the step of:

d2) guiding a welding beam, in particular repeatedly, along a symmetrical or asymmetrical contour. By “contour” is meant, in particular, a welding contour.

It is preferred that step d) comprises the step of:

d3) guiding a welding beam, in particular repeatedly, along an elliptical contour.

It is preferred that step d) comprises the step of:

d4) forming a fusion ring by means of a welding beam.

It is preferred that step d) comprises the step of:

d5) forming a fusion blanket or a molten pool by means of a welding beam.

It is preferred that step d) comprises the step of:

d6) forming a welding bead.

It is preferred that step d) comprises the step of:

d7) starting the welding energy input to the grouped conductor ends. In other words, it is possible to start directing or guiding a welding beam, which has a predetermined energy, to the grouped conductor ends.

It is preferred that step d) comprises the step of:

d8) stopping the welding energy input to the grouped conductor ends.

It is preferred that step d) comprises the step of:

d9) stopping the welding energy input to the grouped conductor ends when the determined value reaches a limit value. By limit value is meant, in particular, a predetermined value that the determined value must not exceed.

It is preferred that step d) comprises the step of:

d10) adjusting, in particular increasing or decreasing, the welding energy input to the grouped conductor ends. In other words, an energy of the welding beam may be adjusted such that the energy is increased or decreased.

It is preferred that step d) comprises the step of:

d11) introducing a predetermined welding energy input, in particular a higher welding energy input, in the case of a height offset between the conductor ends into the conductor end extending further or higher in a main extension direction of the grouped conductor ends. By height offset is meant, in particular, that at least one conductor end is longer or protrudes further relative to another conductor end in a main extension direction of the conductor.

It is preferred that step d) comprises the step of:

d12) distributing a welding energy input according to a tangential offset or tangential offset between the conductor ends. By “tangential offset” it is meant, in particular, that the conductor ends are not congruent, but offset or displaced, in particular further parallel, particularly preferably in one direction, with respect to each other.

It is preferred that step d) comprises the step of:

d13) directing two welding beams, in particular sequential directing of a welding beam or simultaneous directing of two welding beams, to the grouped conductor ends, one welding beam being assigned to one conductor end of the grouped conductor ends and the second welding beam being assigned to a further conductor end of the grouped conductor ends. By sequential guiding is meant, in particular, that first a welding beam is directed to one conductor end and, after a predetermined period of time, the welding beam, in particular the same one, is directed to a further conductor end. In other words, a welding beam is directed to the one conductor end and the further conductor end in succession. By “simultaneous directing” is meant, in particular, that a first welding beam is directed to the one conductor end and a second welding beam, different from the first welding beam, is directed to the further conductor end. In particular, a respective welding beam is directed simultaneously to the one conductor end and to the further conductor end.

It is preferred that step d) comprises the step of:

d14) detecting a point in time at which two individual molten pools combine into one molten pool, the first molten pool being assigned to a first conductor end and the second molten pool being assigned to the second conductor end. In other words, a molten pool can be formed on each of the two conductor ends. By increasing or enlarging or expanding the respective molten pool, the two molten pools may combine into one molten pool. Preferably, a point in time can be determined at which the two molten pools combine into one molten pool.

It is preferred that step d) comprises the step of:

d15) welding the conductor ends, in particular at an end region and/or end face, in a parallel joint. By parallel joint is meant, in particular, that the conductors or conductor ends overlap and lie on top of each other in a wide area.

The welding method comprises that prior to step a) a relative position of a first conductor end and a second conductor end of the grouped conductor ends is detected, wherein the detection takes place by position measurement using optical measuring methods. For example, a relative position of a first conductor end and a second conductor end of the respective group of conductor ends can be detected by a measuring device. The measuring device can be configured differently for this purpose, as long as it can detect the relative positions between the conductor ends and transmit a measurement signal indicating the relative position to a control means 30. This is preferably done by optical measuring methods, such as image capture or optical length measurements, and various measuring devices are available on the market for this purpose. In particular, the measuring device is adapted to measure a plurality of dimensions of the end portion of the conductor end group.

Preferably, the welding method comprises detecting, prior to step a), a relative position of a first conductor end and a second conductor end of the grouped conductor ends, wherein the detection of the relative position is performed by position measurement using time-of-flight measurement of reflected radiation. Other measurement methods based on time-of-flight measurements can also be used. Generally, any measurement principle by which the relative position can be measured is suitable.

Preferably, the welding method comprises detecting prior to step a) a relative position of a first conductor end and a second conductor end of the grouped conductor ends, wherein the detection of the relative position takes place by performing optical coherence tomography.

Preferably, the welding method comprises detecting prior to step a) a relative position of a first conductor end and a second conductor end of the grouped conductor ends, wherein detecting the relative position is performed by alternately directing a measuring beam to different conductor end groups having at least one grouped conductor end.

Preferably, the welding method comprises detecting, prior to step a), a relative position of a first conductor end and a second conductor end of the grouped conductor ends, wherein detecting the relative position is performed or carried out by measuring intervals or distances in at least two dimensions at a conductor end group.

Preferably, the welding method comprises detecting, prior to step a), a relative position of a first conductor end and a second conductor end of the grouped conductor ends, wherein detecting the relative position is performed by measuring an interval or a distance in the direction of extension of the conductor sections comprising the conductor ends.

Preferably, the welding method comprises detecting, prior to step a), a relative position of a first conductor end and a second conductor end of the grouped conductor ends, wherein detecting the relative position is performed by determining a distance between the conductor ends. In other words, a gap or a predetermined distance between the conductor ends can be detected.

Preferably, the welding method comprises detecting, prior to step a), a relative position of a first conductor end and a second conductor end of the grouped conductor ends, wherein detecting the relative position is performed by measuring a height offset between the conductor ends.

Preferably, the welding method comprises detecting, prior to step a), a relative position of a first conductor end and a second conductor end of the grouped conductor ends, wherein detecting the relative position is performed by determining a cross-sectional area of an end region of the grouped conductor ends or at least one conductor end of the conductor ends.

Preferably, the welding method comprises detecting, prior to step a), a relative position of a first conductor end and a second conductor end of the grouped conductor ends, wherein detecting the relative position is performed by determining a tangential offset between the conductor ends.

Preferably, the welding method comprises detecting, prior to step a), a relative position of a first conductor end and a second conductor end of the grouped conductor ends, wherein detecting the relative position is performed by determining a radial offset between the conductor ends.

Preferably, the welding method comprises detecting, prior to step a), a relative position of a first conductor end and a second conductor end of the grouped conductor ends, wherein detecting the relative position is performed by measuring a thickness and/or a width and/or a height of an end region at the conductor end group or the grouped conductor ends.

Preferably, the welding method comprises detecting, prior to step a), a relative position of a first conductor end and a second conductor end of the grouped conductor ends, wherein detecting the relative position is performed by detecting at least one input parameter, wherein as the at least one input parameter a cross-sectional area of an end region of the grouped conductor ends or at least one conductor end and/or a distance between the conductor ends, in particular before welding, and/or a height offset between the conductor ends and/or a radial offset and/or a tangential offset is detected. In particular, the at least one input parameter is detected for determining the value. In other words, input parameters may be considered for determining the value. By determining the one or more input parameters, an initial situation or position of the conductor ends prior to welding can be detected.

Preferably, the welding method correlates the first size parameter, the second size parameter, an extension of the molten pool, a depth of a vapor channel or a vapor capillary at the position of the welding beam, at least one gap dimension, and/or the value to corresponding sizes and/or data sets from preliminary tests. In other words, the first size parameter, the second size parameter, an extension of the molten pool, a depth of a vapor channel or a vapor capillary at the position of the welding beam, at least one gap dimension, and/or the value can be compared or correlated to corresponding sizes and/or data sets from preliminary experiments.

Preferably, the welding method establishes a training data set for neural networks, the training data set comprising the first size parameter, the second size parameter, an extension of the molten pool, a depth of a vapor channel or a vapor capillary at the position of the welding beam, at least one gap dimension, the value, and/or data sets from preliminary experiments.

Preferably, the welding method according to any of the preceding embodiments is performed by means of a welding device according to any of the following embodiments. Preferably, the welding device according to any one of the following embodiments is adapted to perform the welding method according to any one of the preceding embodiments.

According to a further aspect, the invention provides a welding device for welding grouped conductor ends of a component for an electrical machine, comprising:

a welding means for inputting welding energy to grouped conductor ends;

a measuring means for detecting a relative position of a first conductor end and a second conductor end of grouped conductor ends by position measurement using optical measuring methods, the measuring means being further adapted to detect a first size parameter of a molten pool formed during welding and a second size parameter of the molten pool formed during welding, wherein

the measuring means is further adapted to determine a value of the molten pool from the first size parameter, the second size parameter and the relative position, and

a control means configured to control a welding energy input to the conductor ends to be welded depending on the determined value.

It is preferred that the measuring means is configured to evaluate the welding result.

It is preferred that the welding device comprises a comparing means for comparing the value with a predetermined limit value. For example, the comparing means can be integrated in the control means or the measuring means. Preferably, the comparing means is configured to compare the determined value with a predetermined, in particular stored, limit value.

It is preferred that the measuring means is configured to detect the first size parameter by means of optical measuring methods.

It is preferred that the measuring means is configured to detect the first size parameter by means of time-of-flight measurement of reflected radiation.

It is preferred that the measuring means is configured to perform optical coherence tomography.

It is preferred that the measuring means is configured or adapted for arranging a double cross relative to the grouped conductor ends, in particular an end region of the grouped conductor ends, and arranging lines of the double cross relative to each other, in particular at a predetermined distance.

It is preferred that the measuring means is configured for forming a double cross, which is in particular associated with an end region of the grouped conductor ends, larger than a welding contour.

It is preferred that the measuring means for forming a double cross is configured in such a way that a measuring beam, which can be guided along the lines of the double cross, has predetermined jump times and/or jump paths.

It is preferred that the measuring means is configured for directing, in particular alternately directing, a measuring beam to different conductor ends.

It is preferred that the measuring means is configured for directing a measuring beam to the grouped conductor ends in at least two dimensions.

It is preferred that the measuring means is configured for directing a measuring beam to a first conductor end of the grouped conductor ends, in particular a first end region of the first conductor end, and to a second conductor end of the grouped conductor ends, in particular a second end region of the second conductor end, in at least two dimensions.

It is preferred that the measuring means is configured for scanning a measuring beam along a double cross that is assigned to the grouped conductorends, the double cross respectively comprising two lines arranged in the x- and y-directions, which are arranged, in particular, at a predetermined distance from one another.

It is preferred that the measuring means is configured for detecting an extension, in particular a lateral extension, of the molten pool as a first size parameter, in particular in a plane of the grouped conductor ends.

It is preferred that the measuring means is configured for detecting at least one input parameter, wherein a cross-sectional area of an end region of the group of conductor ends or at least one conductor end and/or a distance between the conductor ends, in particular prior to welding, and/or a height offset between the conductor ends and/or a tangential offset and/or a radial offset is detected as the at least one input parameter.

It is preferred that the measuring means is configured to detect the second size parameter by means of optical measuring methods.

It is preferred that the measuring means is configured to detect the second size parameter by means of time-of-flight measurement of reflected radiation.

It is preferred that the measuring means is configured to perform optical coherence tomography.

It is preferred that the measuring means is configured to guide a measuring beam to a position of a welding beam.

It is preferred that the measuring means is configured to detect the second size parameter at a position of a welding beam.

It is preferred that the measuring means is configured for detecting a depth of a hole or a vapor capillary or a vapor channel, in particular a keyhole, at a position of a welding beam.

It is preferred that the measuring means is configured for detecting a depth of a hole or a vapor capillary or a vapor channel, in particular a keyhole, at a position of a welding beam in a main extension direction of the grouped conductor ends.

It is preferred that the measuring means is configured for detecting a gap depth at a gap crossing of a measuring beam and/or a welding beam.

It is preferred that the measuring means is configured for detecting a molten pool depth.

It is preferred that the measuring means is configured for detecting a molten pool depth on a surface of at least one conductor end or of the grouped conductor ends.

It is preferred that the measuring means is configured for detecting at least one input parameter, wherein a cross-sectional area of an end region of the group of conductor ends or of at least one conductor end and/or a distance between the conductor ends, in particular prior to welding, and/or a height offset between the conductor ends and/or a tangential offset and/or a radial offset is detected as the at least one input parameter.

It is preferred that the measuring means is configured for determining a molten pool dimension of the molten pool as a value of the molten pool.

It is preferred that the measuring means is configured for determining an increase in a melt volume as a value of the molten pool.

It is preferred that the measuring means is configured for determining a connection cross-section of the grouped conductor ends as a value of the molten pool.

It is preferred that the measuring means is configured for position measurement by means of time-of-flight measurement of reflected radiation.

It is preferred that the measuring means is configured to perform optical coherence tomography.

It is preferred that the measuring means is configured for alternately directing a measuring radiation to different conductor end groups, which has at least one grouped conductor end.

It is preferred that the measuring means is configured for measuring intervals or distances in at least two dimensions at a conductor end group.

It is preferred that the measuring means is configured for measuring an interval or distance in the direction of the extension of the conductor sections comprising the conductor ends.

It is preferred that the measuring means is configured for determining a distance between the conductor ends.

It is preferred that the measuring means is configured for measuring a height offset between the conductor ends.

It is preferred that the measuring means is configured for determining a cross-sectional area of the end region of the grouped conductor ends or at least one conductor end of the conductor ends.

It is preferred that the measuring means is configured for determining a tangential offset between the conductor ends.

It is preferred that the measuring means is configured for determining a radial offset between the conductor ends.

It is preferred that the measuring means is configured for measuring a thickness, a width and/or a height of the end region at the conductor end group.

Of course, the measuring means can be configured to perform individual and/or several of the aforementioned measuring functions.

Preferably, the control means is configured for controlling the welding device for directing a welding beam to the grouped conductor ends.

Preferably, the control means is configured for controlling the welding means to direct a welding beam along a symmetrical contour. In embodiments, the welding beam may also be driven along an asymmetrical contour.

Preferably, the control means is configured for controlling the welding means to direct a welding beam along an elliptical contour.

Preferably, the control means is configured for controlling the welding means for forming a fusion ring by means of a welding beam.

Preferably, the control means is configured for controlling the welding means for forming a fusion blanket by means of a welding beam.

Preferably, the control means is configured for controlling the welding means to form a welding bead.

Preferably, the control means is configured for controlling the welding means to start the welding energy input to the grouped conductor ends.

Preferably, the control means is configured for controlling the welding means to stop the welding energy input to the grouped conductor ends.

Preferably, the control means is configured for controlling the welding means to stop the welding energy input to the grouped conductor ends when the determined value reaches a limit value. In particular, the control means is arranged to receive a signal from the comparing means as soon as the value reaches a limit value.

Preferably, the control means is configured for controlling the welding means to adjust, in particular to increase or decrease, the welding energy input to the grouped conductor ends.

Preferably, the control means is configured for controlling the welding means to apply a predetermined welding energy input, in particular a higher welding energy input, to the conductor of the grouped conductor ends which extends further or higher in a main extension direction, in the event of a height offset between the conductor ends.

Preferably, the control means is configured for controlling the welding means to distribute a welding energy input according to a tangential offset between the conductor ends.

Preferably, the control means is configured or arranged to control the welding means for directing two welding beams to the grouped conductor ends, in particular sequentially directing one welding beam or simultaneously directing two welding beams, wherein one welding beam is associated with one conductor end of the grouped conductor ends and the second welding beam is associated with another conductor end of the grouped conductor ends.

Preferably, the control means is configured for controlling the welding device to detect a point in time at which two individual molten pools combine into one molten pool, wherein the first molten pool is associated with a first conductor end and the second molten pool is associated with the second conductor end.

Preferably, the control means is configured for controlling the welding means for welding the conductor ends, in particular at an end region and/or on the end face, in a parallel joint.

Of course, the control means can be configured for performing individual and/or several of the aforementioned control functions.

The invention also includes further developments of the welding device with features already described in context with the further developments of the method according to the invention. For this reason, the description of the corresponding further developments of the welding device according to the invention will not be repeated in the following.

According to a further aspect, the invention provides a computer program product comprising machine-readable control instructions which, when loaded into a controller of a welding device according to any of the preceding embodiments, cause the welding device to perform the welding process according to any of the preceding embodiments. A controller in which such control instructions are loaded is an exemplary embodiment of the control means of the preceding designs.

Effects, functions and advantages of preferred embodiments of the invention are described in more detail below.

The contacting of copper wires (also called copper pins) to be electrically interconnected is carried out by means of substance-to-substance connections, which can be realized by various welding methods. In addition to various beam welding processes, such as laser beam or electron beam welding, arc-based processes, such as TIG and plasma welding, are also established in the prior art.

Preferably, the pins to be contacted are welded in a parallel joint at their free ends, with the geometry of the weld forming a bead-shaped or hemispherical contour.

Preferably, depending on the required mechanical and electrical properties, the connection cross-section, which is preferably formed as a material-to-material connection between the joining partners in the parallel plane of the joint, is individually set via the melt volume and/or the bead height. In the welding process, the energy is preferably input over a flat area so that the end face is completely melted and a closed fusion blanket is produced. Preferably, the energy is introduced along a characteristic welding contour whose geometry and dimension are selected as a function of the wire cross section, particularly preferably in laser beam welding. The dimension of these contours preferably extends over the entire cross-section of the pin pair so that a constant and uniform fusion blanket is produced. In particular, a characteristic melt volume is required or provided as a function of the required connection cross-section. Preferably, a repetition of the weld contour is provided for this purpose until the required connection cross-section is achieved.

The state of the art for inline analysis of the weld depth is the measurement of the keyhole depth, as described and shown in reference [1]. However, this can only quantify the weld depth and not the fusion volume and thus the connection cross-section when welding copper wires. Moreover, in the prior art, there is no system-technical measuring means for inline analysis of the process zone dimension and thus for situation-dependent control of the energy input. Preferably, the process-technical control variables are selected in such a way that the required connection cross-section is achieved even if unfavorable boundary conditions exist with regard to the pin positions. In comparison, an overdimensional energy input can result under ideal boundary conditions. In principle, however, this can have a negative effect on minimizing the paint-stripped length and the welding time. In the worst case, with a combination of unfavorable boundary conditions with regard to the position offsets of the pins, tolerances cannot be compensated arbitrarily, or the process parameters cannot be configured in such a way that the required connection cross-sections are achieved. Such boundary conditions can result in a welded joint whose connection cross-section does not meet the requirements and thus represents a “niO” (“not in order”). For example, a stator has between 150 and 300 welded joints, and even a single welded joint “niO” results in rejection of the entire stator. This preferably requires a situation-dependent adjustment and control of the energy input so that the required connection cross-sections can be achieved depending on the process zone growth and/or molten pool growth. Preferably, this can be achieved with a measuring device, in particular an inline measuring tool, that can quantify the molten pool geometry during the welding process.

In addition, an upstream position measurement of the pins is preferably carried out, since individual positions may exist in the x-, y- and z-directions. Furthermore, an inline measurement of the process zone growth is also preferably carried out for each welding process in order to be able to implement the energy input situationally. In addition, the molten pool dimension in combination with the keyhole depth is preferably used to determine the connection cross-section in the joint. By “keyhole” is meant, in particular, a vapor channel due to the phase transformation in the focal spot of the laser.

Process monitoring systems currently established in the prior art are limited to the detection of process emissions and also exclusively evaluate the constancy of these evaluation variables. In addition to thermal variables, the process glow is also detected and evaluated with regard to its constancy and scattering range. Currently, the preferred method is to determine the connection cross-section on the basis of process emissions. In this specific case, the cooling behavior is quantified in particular via the thermal radiation and the melt volume or the connection cross-section in the gap is inferred from this.

A measurement strategy for determining the connection cross-section is proposed, which is based in particular on OCT technologies that can be used by a wide range of users.

Embodiments of the invention provide for a measuring system in which the OCT measuring beam is used to measure the molten pool dimension in the x- and y-directions, i.e., in the plane of the wire cross sections, inline, i.e., during the welding process. Furthermore, preferably also by means of OCT, the molten pool dimension is measured in the z-direction, i.e., in particular in the wire direction. The measurement is preferably made in the keyhole, which results in a vapor channel in the direction of the beam in the molten pool due to evaporation of melt, and which is almost exclusively filled with gaseous metal, and only this depth can be measured with the light beam of the OCT. By “keyhole” is preferably meant a vapor channel at the location of the laser spot, i.e., at the point of energy input, where the metal vaporizes. This depth of the path measured with gaseous metal preferably serves as height information in the z-direction, from which, as will be described below, additional with the extension of the molten pool in the x- and y-directions, the wire cross-section as well as the distance between the wires before welding as well as their height offset, the connection cross-section can be calculated.

Alternatively or additionally, data sets from preliminary experiments on different wire cross sections with different gap dimensions and different molten pool dimensions in the x-, y- and z-directions can preferably be used to correlate the connection cross-sections to the parameters mentioned. Preferably, a neural network training data set can be created here, and after training, the connection cross-sections can be determined as a function of the input parameters.

Compared to the solutions established in the prior art, the invention offers a significant procedural advantage, since a direct quantification of the evaluation variables in the detail of the molten pool dimension is performed on the basis of the actual situation.

In particular, the proposed method makes it possible to respond to individual conditions, especially different offsets of wire ends, and to achieve a constant connection cross-section. This should make it possible, for example, to dispense with cutting the wire ends to a uniform height level. Preferred embodiments of the invention allow quantification in order to control the energy input depending on the situation, resulting in a melt volume that produces the required connection cross-section. This also makes it possible to avoid overdimensioned energy input as well as thermal damage to the insulating varnish and, at the same time, connection cross-sections that are too small due to unfavorable boundary conditions.

Preferably, the developed measurement strategy allows inline quantification of the process zone geometry and thus the control of the energy input to achieve the required connection cross-section.

Preferred system design: The measurement system is based on optical coherence tomography, OCT for short. A measuring beam with a wavelength of approximately 840 nm is emitted. The height information of the component in the z-direction is determined by calculating the propagation time of the reflected signal.

The measurement strategy can be implemented as a double cross. Before the welding process, the OCT is used to determine the positions of the uncut hairpins relative to each other in the x-y-z direction. Furthermore, during the welding process the process zone dimensions are measured in x-, y- and z-direction. On the one hand, the molten pool dimension is determined in the x- and y-directions using a hashtag measurement strategy, and alternately the keyhole depth, i.e., the molten pool dimension in the z-direction. The lateral extent of the molten pool in x- and y-directions is determined via two lines, each arranged in x- and y-directions with a defined distance to each other. The OCT measuring beam is guided exclusively along the lines during the measurement. Volume expansion in the area of the molten pool shortens the measured path length and/or runtime of the measuring beam, so that it is possible to draw conclusions about melt within the contour. This means that after a complete scan of the contour, it can be determined whether the inner surface of the contour is completely filled with melt. It is particularly important here to arrange the contour appropriately via the position of the lines relative to the wire ends and relative to each other. Here, a small edge distance is preferably provided, whereby the hashtag or double cross is preferably larger compared to the dimension of the weld contour. Experiments can be made to determine the minimum spacing of the lines required to establish the molten pool dimension in the x- and y-directions, by means of which the required connection cross-section is achieved. The hashtag is preferably configured in a circumferential manner so that minimum jump paths and/or jump times result. After a complete scan of the hashtag, it is possible to switch to the measurement of the keyhole by the measurement beam jumping to the current position of the laser spot and measuring the depth of the keyhole there. The determination of the molten pool dimension is necessary because there are cases where not the entire wire cross-section is melted, for example in the case of a wide gap where the melt flows into the gap. In the case of a line spacing which is too large, if the gap is large, the melt may not reach the hashtag lines and thus too much energy would be introduced, even though there is already a sufficient connection cross-section before reaching lines. After the measurement, the location-related depth of the molten pool and the molten pool dimension in x- and y-directions are known. From this, the melt volume is calculated by means of geometric observation. In the case of symmetrical positional differences of the wires to be welded, an asymmetrical molten pool is created along the contact surface, since the energy input is symmetrical, for example via elliptical contours, and heat conduction leads to a uniform energy distribution into the two pins in the case of equal irradiation portions. Depending on the progress of the measurement and the progress of the melting, the increase in melt volume is determined and thus the connection cross-section. When a limit value is reached, the emission of the laser energy is stopped.

Component-specific adjustment of the energy input as a function of the cross-sectional area of the pin pair, i.e., the irradiation location and the area energy, can be controlled as a function of the wire cross-section and the measurement signal (OCT).

Furthermore, in a preferred embodiment, the following boundary conditions are considered:

A) height offset

B) tangential offset and/or lateral offset

C) radial offset and/or gap.

Preferably, the surface energy is implemented in accordance with the present geometric boundary conditions A to C, so that a homogeneous weld bead is produced.

Particularly in the case of a height offset, especially in case A), the main part of the energy is preferably applied to the higher pin so that there is an identical height level of both welded wires. During gap crossing, the keyhole depth is preferably measured and used as a measured variable for calculating the connection area.

Particularly in case B, a distribution of the surface energy is preferably carried out according to the existing tangential offset. In particular, when using elliptical weld contours, the longitudinal axis is to be rotated accordingly so that it intersects the centers of the individual pins. Accordingly, the contour of the double cross is to be set at an angle. Analogous to A), the joint plane of the joining partners is preferably used to evaluate the process zone depth.

In particular in case C), two pin-related weld contours are preferably implied to avoid energy input into the gap. The measurement contour in the form of a double cross can be maintained. In particular, the point in time at which the two individual molten pools combine into a common molten pool must be tracked. With regard to the measurement of the molten pool depth, the keyhole depth cannot be used as an evaluation variable because the keyhole is open at the bottom, so that little or no signal response is returned. The information of the molten pool depth in the gap is preferably to be drawn here from the molten pool depth on the pin surface.

### BRIEF DESCRIPTION OF THE DRAWINGS

Embodiments of the invention will be described in more detail below with reference to the accompanying drawings wherein it is shown by:

FIG. 1 shows a welding arrangement comprising a welding device with a welding means, a measuring means and a control means for welding grouped conductor ends of a component for an electrical machine;

FIG. 2a-2e show a schematic representation of a top view of a pair of conductor ends to be welded with process zone conditions at different times of a welding process or progress of the process including measuring lines;

FIG. 3 show a schematic representation of a sectional view of a pair of conductor ends to be welded in the region of a keyhole with a measuring beam directed thereon;

FIG. 4a, 4b show a schematic representation of a sectional view of the pair of conductor ends to be welded with a weld seam;

FIG. 5 shows a perspective view of another pair of conductor ends with different relative positions of the conductor ends before welding;

FIGS. 6a -6d show an isometric view respectively of the pair of conductor ends to be welded at different times of a welding process or a progress of the process corresponding to the states of FIGS. 2a to 2d in perspective view;

FIGS. 7a -7d show an isometric view respectively of the pair of conductor ends to be welded at different times of a welding process or a progress of the process corresponding to the states of FIGS. 2a to 2d in side view;

FIGS. 8a -8d show an isometric view respectively of the pair of conductor ends to be welded at different times of a welding process or a progress of the process corresponding to the states of FIGS. 2a to 2d in plan view;

FIGS. 9a -9b show a side view respectively of the pair of conductor ends to be welded, with a height offset of the conductor ends;

FIG. 10 shows a schematic representation of the pair of conductor ends to be welded, with a gap between the conductor ends, in a plan view; and

FIG. 11 shows a schematic representation of the pair of conductor ends to be welded, with a tangential offset between the conductor ends, in a plan view.

### DETAILED DESCRIPTION OF THE PREFERRED EMBODIMENTS

The embodiments explained below are preferred embodiments of the invention. In the embodiments, the described components thereof each represent individual features of the invention which are to be considered independently of one another and which each develop the invention independently of one another. For this reason, these features are also to be considered as part of the invention, either individually or in a combination other than that shown. Furthermore, the embodiments described can also be supplemented by further ones of the features of the invention already described.

In the Figures, identical elements or elements having an identical function are identified by same reference signs.

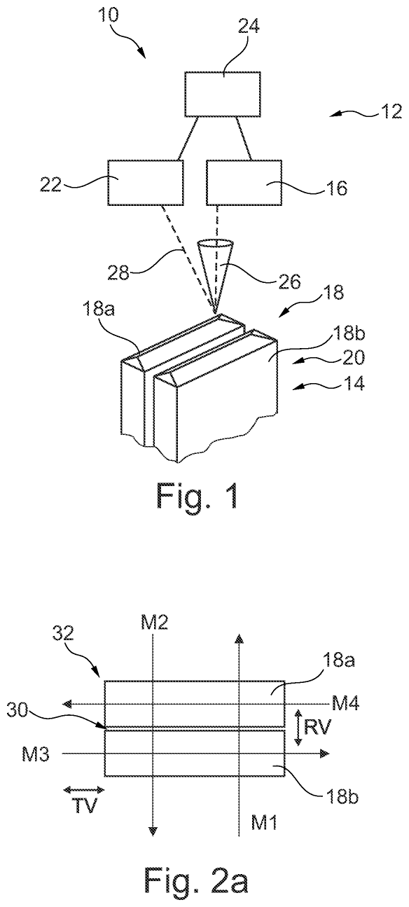

FIG. 1 shows a schematic representation of a welding arrangement 10 with a welding device 12 and a component 14 to be processed. Conductor ends 18, 18a, 18b protrude from the component 14. In FIG. 1, a pair of conductor ends 20 is shown. The component 14 preferably comprises a plurality of conductors, in particular electrical conductors, and a plurality of pairs of conductor ends 20. The conductor ends 18, 18a, 18b are arranged side by side in pairs.

The component 14 is a component of an electric machine to be mass-produced, such as an electric motor to be used as a drive motor for electric or hybrid vehicles. Coil windings of the component 14 are produced by connecting conductor ends 18, in particular pairs of conductor ends 20.

For example, the component 14 is a stator of the electric motor. The conductor ends 18 are, for example, the ends, referred to as pins, of hairpins, that is, U-shaped pieces of wire, in particular rectangular wire, which are inserted into grooves of a housing or stack of laminations of the stator. By connecting the free ends of the hairpins, i.e., the pairs of conductor ends 20, the coil windings extending through the stator in a wave-like manner can be formed.

Before the coil windings are welded together, a large number of conductor ends 18 protrude from one end of the housing or one end face or surface, usually grouped into pairs of conductor ends 20. In FIG. 1, such a pair of conductor ends 20 is shown schematically. A first conductor 18a and a second conductor 18b of the pair of conductor ends 20 are to be welded together by means of a welding means 16 of the welding device 12, in particular to connect one hairpin to another hairpin. However, it may also be the case that three or more conductor ends 18 are to be connected together, which is then also to be carried out by the welding or welding process described in more detail below.

Prior to welding, the conductors, in particular the conductor ends 18a, 18b of each pair of conductor ends 20 to be welded together, are braced with each other. For this purpose, the welding device 12 may, for example, comprise a bracing means (not shown in Figures). The welding operation is explained below with reference to an example involving the pair of conductor ends 20.

For welding at least one pair of conductor ends 20, the welding device 12 comprises the welding means 16, a measuring means 22 and a control means 24. The control means 24 is coupled or connected for signaling to the measuring means 22 and/or the welding means 16, particularly in a wired or wireless fashion. The control means 24 is arranged to control the welding means 16 and/or the measuring means 22. In addition, the measuring means 22 may be arranged to transmit or send acquired parameters or values or measured variables to the control means 24. For example, the control means 24 may be configured as a control unit or controller. For example, the control means 24 has a control unit comprising a computing unit and a memory in which control instructions are stored as software.

The welding means 16 is arranged to output a welding beam 26 which is directed to a predetermined position on or at the component 14, in particular to the pair of conductor ends 20. In other words, the welding means 16 is configured to apply welding energy to the component 14, in particular the pair of conductor ends 20. In particular, the welding means 16 is configured to direct the welding beam 26 successively to a plurality of conductor ends 18. For example, the welding means 16 may be configured for beam welding. Particularly preferably, the welding means 16 may be configured for laser beam welding. Alternatively, the welding means 16 may also comprise a TIG or plasma welding device, wherein the conductor ends are moved into the welding zone one after the other.

In the preferred embodiment shown in FIG. 1, the welding means 16 has a laser for generating a laser beam as a welding beam 26 for laser welding. Hence a beam welding process is preferably performed. The welding beam 26 has a predetermined energy. The welding means 16 is further adapted to guide or direct the welding beam 26. For example, the welding beam 26 may be moved along a predetermined contour 36 by the welding means 16. The guiding or directing of the welding beam 26 may be implemented by an optical system, in particular a laser optical system, for deflecting and focusing the welding beam 26, in particular the laser beam. For example, if a laser optical system is used as the optical system, the optical system may in particular comprise one or more galvanometrically driven deflection mirrors and/or an optical element for focusing the laser beam and for adjusting the beam cross-section of the laser beam. The laser optical system may also include apertures for blanking out all or an adjustable amount of the laser beam. Thus, the laser optical system is an example of a means for directing a welding beam 26 to the conductor end group 20, and an example for starting, stopping, increasing and decreasing the welding energy input to the conductor end group 20. At least some of these functions may, of course, be performed by other suitable means, such as on the laser itself or at or in the beam path between the laser and the laser optical system.

The measuring means 22 is arranged to output a measuring beam 28. In this regard, the control means 24 is particularly adapted to control the measuring means 22 to output the measuring beam 28. For example, the measuring means 22 can output the measuring beam 28 prior to welding and thus measure or gauge the component 14 or the conductor ends 18 or determine their position. Additionally or alternatively, the measuring means 22 may be arranged to output the measuring beam 28 as soon as welding begins. In this case, the measuring means 22 is arranged to direct the measuring beam 28 to the component 14, in particular to the pair of conductor ends 20. The measuring means 22 is also arranged to guide or direct the measuring beam 28. In this context, the measuring means 22 is preferably set up to use the measuring beam 28 to move along or scan the component 14, in particular the pair of conductor ends 20, according to a predetermined pattern or according to predetermined lines, in particular measuring lines or dimension lines, and/or to guide the measuring beam 28 to a predetermined position. For example, the predetermined pattern or lines may be a double cross, which may also be referred to as a hashtag. For example, the predetermined position may be a current position of the welding beam 26 or a position of a laser spot, which is the focal point at which the welding beam hits the component 14.

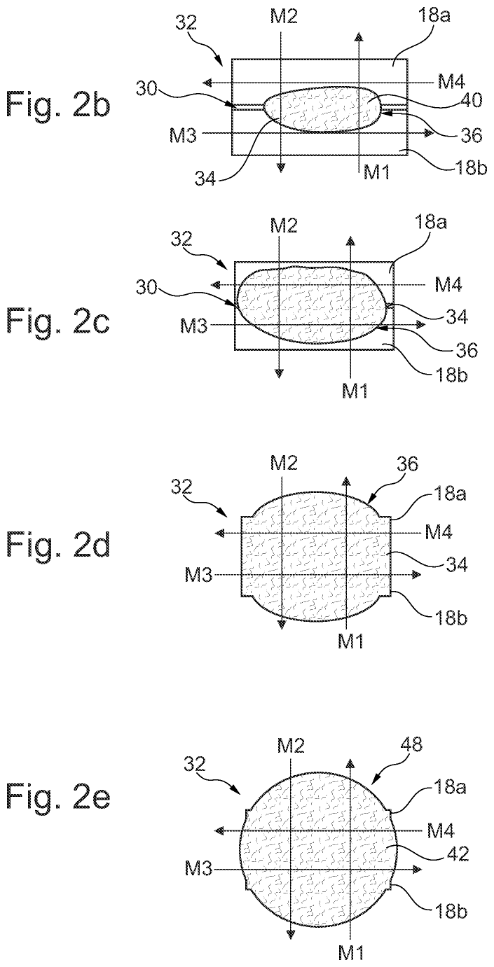

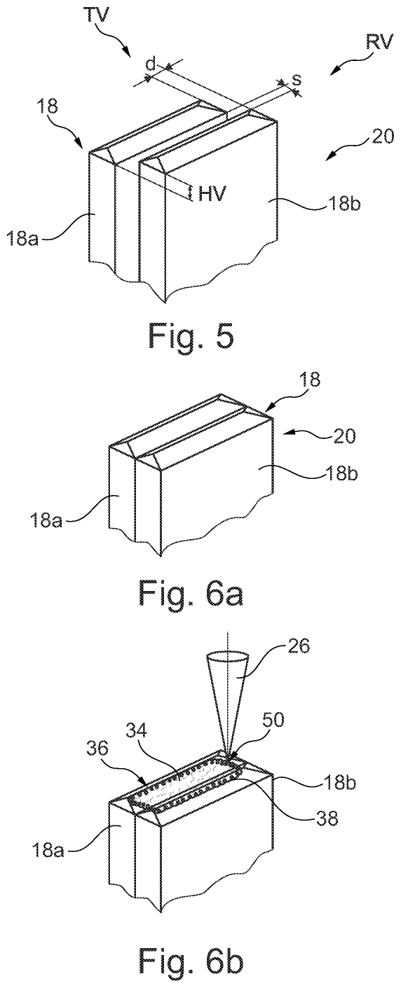

Prior to welding, input parameters of the component 14 or the pair of conductor ends 20 to be welded must be determined or acquired. In other words, an initial situation of the pair of conductor ends 20 to be welded may be detected. Preferably, this initial situation or the input parameters are detected by the measuring means 22. Preferably, a cross-sectional area of an end region 32 of the grouped conductor ends 18 or at least one conductor end 18 and/or a distance between the conductor ends 18, 18a, 18b or a radial offset RV, which is, in particular, related to the radial direction of the component 14 having a central axis, and/or a gap 30 between the conductor ends 18 and/or a height offset HV between the conductor ends 18 and/or a tangential offset TV between the conductor ends 18 and/or a relative position of the conductor ends are detected as input parameters. The at least one or more input parameters are preferably collected by the measuring means 22. The pin positions or positions of the conductor ends 18 can be characterized with respect to the input parameters, particularly preferably with respect to HV, RV and TV. In FIGS. 2a, FIG. 5, FIG. 6a, FIG. 7a and FIG. 8a, examples of corresponding initial situations in which the conductor ends may be arranged prior to welding are shown. In particular, FIG. 5 specifically highlights or illustrates the tangential offset TV, the radial offset RV, and the height offset. For example, a welding energy input may additionally or alternatively be controlled depending on the collected input parameter or parameters.

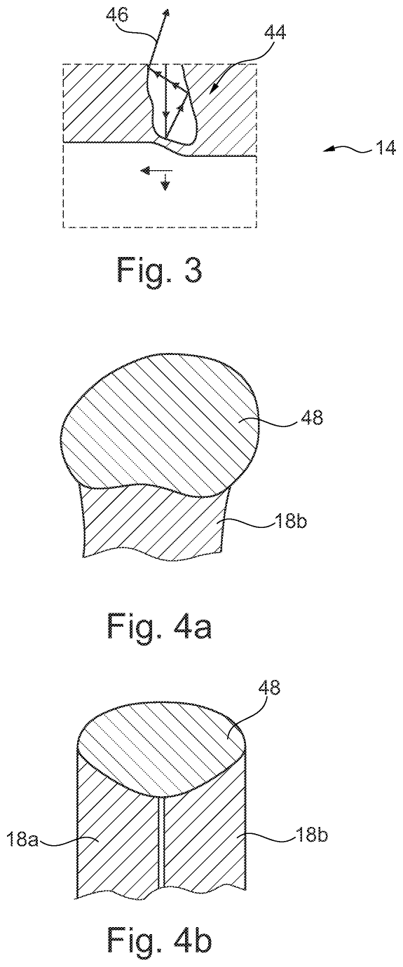

Moreover, the measuring means 22 is adapted to detect a first size parameter and a second size parameter of a molten pool 34 formed during welding. In other words, the measuring means 22 is arranged to detect or measure at least two size parameters of the molten pool 34 during welding. As a first size parameter, in particular an extension or expansion or length of the molten pool 34 in a predetermined first direction and a predetermined second direction, in particular in one plane or two dimensions, is detected. For example, an extension of the molten pool 34 in an x-direction, which extends in particular parallel to a cross-sectional area or transverse plane of the conductor ends 18, and in a y-direction, which extends in particular perpendicular to the x-direction and/or parallel to a cross-sectional area or transverse plane of the conductor ends 18, is detected. The detection of the expansion of the molten pool 34 in the x- and y-directions will be discussed in more detail below in connection with FIGS. 2a to 2e. In particular, a depth of a hole, in particular a keyhole 44, at the current position of the welding beam 26 is detected as a second size parameter. In other words, an extension or an expansion of the molten pool 34 in a z-direction, which extends, in particular, perpendicular to the x- and y-directions or perpendicular to the cross-sectional area or in a main extension direction of the conductor ends 20, is detected. The detection of the expansion of the molten pool 34 in the z-direction will be discussed in more detail in connection with FIG. 3. Thus, by means of the first size parameter and the second size parameter, in particular a geometry of the molten pool 34 or a molten pool geometry is detected or determined.

In addition, the measuring means 22 is arranged to determine or detect or calculate a value of the molten pool 34 from the first size parameter and the second size parameter. In particular, a connection cross-section is calculated as the value. Additionally or alternatively, the control means 24 may also be arranged to calculate the value of the molten pool 34. For this purpose, the measuring means 22 may transmit or transfer the detected or determined size parameters to the control means 24.

Finally, the control means 24 is adapted to control a welding energy input depending on the determined value of the molten pool 34. In particular, the value to be determined results from the input parameter or parameters and/or the first size parameter value and/or the second size parameter value. The control means 24 or a comparing means (not shown in the Figures), which may form part of the measuring means 22 or the control means 24, is further arranged to compare the determined value with a limit value, i.e., in particular a predetermined value of a connection cross-section. Once the determined value has reached the limit value, the control means 24 controls the welding means 16 to stop the welding energy input, i.e., the output of the welding beam 26. Additionally or alternatively, the control means 24 may be arranged to control the welding means 16 in such a way that a welding energy input is increased or reduced, depending on the determined value.

In the preferred exemplary embodiment shown in FIG. 1, the measuring means 24 operates via time-of-flight measurement of reflected measuring radiation 28. Particularly preferably, the measuring means 22 operates using optical coherence tomography (OCT). For this purpose, the measuring means 22 has, for example, an OCT device. The OCT device may comprise a deflection means, which is, in particular, also referred to as a scanner. Such OCT devices for performing optical coherence tomography are available on the market for completely different purposes as can be seen, for example, from the following literature:

[2] “Optical coherence tomography”, entry in Wikipedia, wikipedia.org, retrieved on May 12, 2021.

They are currently used in medicine, particularly for detecting the fundus of the eye in ophthalmology. The deflection device of the OCT device allows a measuring beam 28 of the OCT device to scan or be guided over the respective conductor ends 18. Thus, the measuring means 24 is adapted to detect a position of the contours of the individual conductor ends 18 or also the contours, the dimensions and the volume of the molten pool 34, hence the first and the second size parameters, or of the welding bead 42 or the welding seam 48.

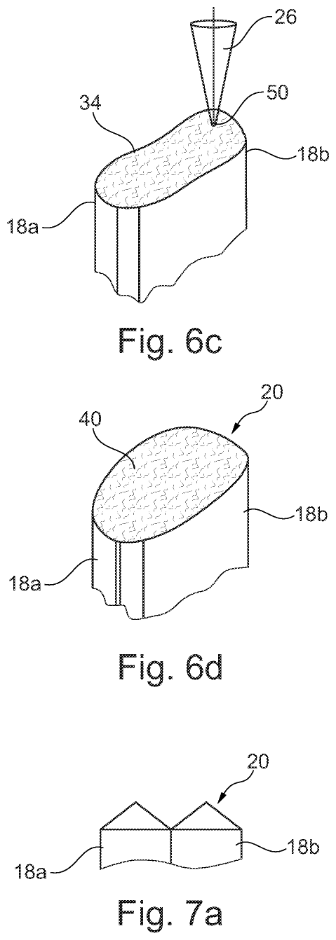

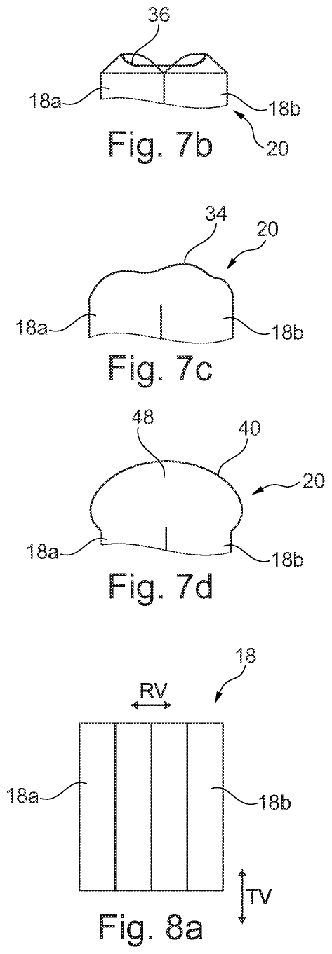

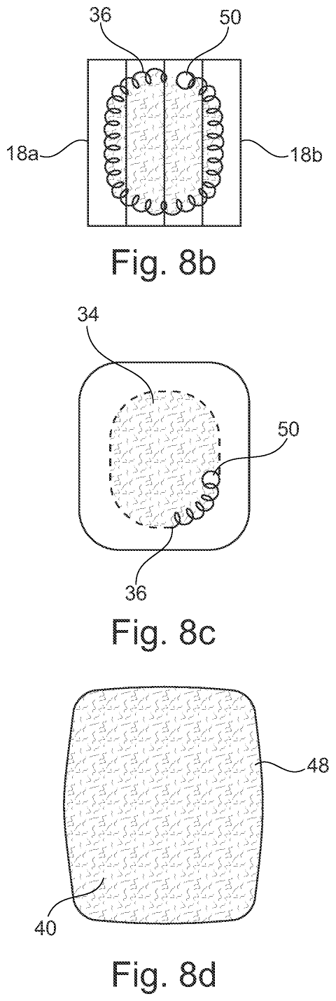

In connection with FIGS. 2a to 2e, FIGS. 6a to 6d, FIGS. 7a to 7d, FIGS. 8a to 8d and FIG. 3, the detection of the first size parameter and the second size parameter by means of the measuring means 22, in particular the OCT device, will be discussed in more detail. Prior to the welding process, the measuring means 22 is used to determine the positions and/or contours of the uncut hairpins in the x-y-z direction, i.e., in particular the positions of the conductor ends 18a and 18b, relative to one another. In particular, as is shown schematically in FIG. 5, the input parameters, especially preferably the tangential offset TV, the radial offset, a gap 30 between the conductor ends 18a, 18b and/or a height offset HV and/or a relative position, are detected or determined here. This initial situation before welding is shown in FIG. 2a, FIG. 6a, FIG. 7a and FIG. 8a. Here, the measuring device emits the measuring beam 28, in particular, with a defined wavelength, preferably of 840 nm.

The measurement strategy is configured as a double cross, as shown in

FIGS. 2a to 2e. The double cross has four lines or measuring lines M1 to M4, as can be seen in FIGS. 2a to FIG. 2e. In particular, the double cross is arranged in a plane relative to the end region 32 of the conductor ends 18 relative to the end region. In other words, the double cross may be in a plane with the end portion 32 or the end surfaces of the conductor ends 18, 18a, 18b. In other words, the double cross may be placed or projected on the end region 32 of the grouped conductor ends 18. The double cross has the four measuring lines M1 to M4, two of which are arranged parallel to each other at a predetermined distance, i.e. M1-M2 and M3-M4, and the respective pair of lines of which the two lines run parallel to each other runs or is arranged perpendicular to the other pair of lines, i.e. the two pairs of lines are arranged or set up in a cross to each other.

By means of this measurement strategy, the molten pool dimension is first determined in the x- and y-directions during welding. In other words, an expansion or extension or dimension of the molten pool 34 is determined as a first size parameter, in particular in a plane or in two dimensions perpendicular to the main extension direction of the conductor ends 18 or conductors. The lateral extension of the molten pool 34 in the x- and y-directions is thereby determined in particular via the two lines respectively arranged in the x- and y-directions, the measuring lines M1 to M4, with a defined spacing from one another. At the measurement during welding, the measuring beam 28 is guided exclusively along the measuring lines M1 to M4. The molten pool 34 is formed during welding. The molten pool 34 is formed as the welding beam 26 impinges on the component 14, in particular the conductor ends 18. An expansion of the molten pool 34, in particular a volume expansion in the area of the molten pool 34, shortens the measured distance or travel time of the measuring beam 28. Thus, a geometric change of the molten pool 34 can be detected. This can additionally or alternatively serve as an input variable for dimensioning the energy input. The expansion of the molten pool 34 is formed, in particular, by the fact that the welding beam 26 is moved along the contour 36, i.e., travels along the component 14, in particular along the conductor ends 18 with a predetermined distance and melts the component 14 in this area. Due to the expansion of the molten pool 34 and with the distance or running time measured shortening with it, a conclusion can be drawn about the melt, i.e., the molten pool 34, within the contour 36. In other words, after a complete contour run, it can be determined whether the inner surface of contour 36 is completely filled with melt. By contour 36 is meant, in particular, a path along which the welding beam 26 is moved, in particular on the conductor ends 18 or the end region 32 of the conductor ends 18. As shown, in particular in FIG. 6b and FIG. 6c, the welding beam 26 is moved along a predetermined contour 36. The contour 36 may also be referred to as the welding contour. In particular, the welding beam 26 travels along an elliptical contour 36. Thus, while the welding beam 26 travels along the predetermined contour 36, the measuring beam 28 is simultaneously guided along the measuring lines M1 to M4. Once the welding beam 26 has travelled along the contour, especially the elliptical contour, while the welding beam 26 moves along the contour 36, the measuring beam 28 can travel along the measuring lines M1 to M4 and can determine, as soon as the welding beam has completely travelled along the contour 36, whether the contour 36, i.e. especially the interior thereof, is filled with melt. The welding beam 26 can also travel over the contour multiple times. In doing so, the welding beam 26 can travel over the contour 36 or various contours several times until the desired welding result or expansion of the molten pool 34 is achieved. Figures FIG. 2b, FIG. 6b, FIG. 7b and FIG. 8b show how the welding beam 26 travels along such a contour 36. A spot or focal point is formed at the position where the welding beam 26 hits the component 14. Since a laser beam is used as the welding beam 26, a so-called laser spot 50 is formed. The laser beam is moved along an elliptical contour 36 until a fusion ring 38 is formed. With the measurement strategy, the process zone dimension can be measured iteratively during the welding process by measuring the dimensions of the molten pool 34 along the measuring lines M1 to M4. This allows defined limit values of the connection cross-section to be achieved.

FIG. 2c and FIG. 2d, FIGS. 6c and 6d, FIGS. 7c and 7d and FIGS. 8c and 8d illustrate the further process progress during welding. Shown therein is the enlargement of the contour 36 and the molten pool 34. FIG. 2e shows the resulting weld bead 42 and the weld 48. In FIG. 4a, the weld 48 is shown or illustrated in a longitudinal section to a plane of the joint. In FIG. 4b, the weld 48 is shown in cross-section.

In the measuring strategy as shown in FIGS. 2b to 2e, in particular the contour 36 is arranged via the position of the measuring lines M1 to M4 relative to the conductor ends 18 and relative to each other. Here, in particular, a predetermined edge distance is maintained, the double cross being configured to be larger in comparison with the dimension of the predetermined contour 36. By means of experiments, for example, it can be determined which minimum distances of the measuring lines M1 to M4 are required or have to be assumed relative to one another in order to determine the molten pool dimension in the x- and y-directions by means of which a required connection cross-section is achieved. In addition, the double cross is configured especially circumferentially in in such a way that minimum jump paths and/or jump times result.

The input parameter or parameters, which are determined, in particular, before welding, are determined by the measuring means 26 also using, in particular, this measuring strategy with the four measuring lines M1 to M4.

FIG. 6a to FIG. 6d, FIG. 7a to FIG. 7d and FIG. 8a to FIG. 8d show the stages in the welding process, from an initial state (FIG. 6a, FIG. 7a and FIG. 8a) via the formation of a fusion ring 38 and the closing of the fusion blanket 40 to a formation, in particular complete formation, of a bead 42 or melt bead. FIG. 6a, FIG. 7a and FIG. 8a show an initial state prior to the welding process. FIG. 6b, FIG. 7b and FIG. 8b show how the welding beam 26 is guided along the predetermined, elliptical contour 36. Once the welding beam 26 has completely travelled along the contour 36, a fusion ring 38 or the closed melt contour is formed. FIG. 6c, FIG. 7c and FIG. 8c show the closed fusion blanket 40 or the molten pool 34 within the contour 36. FIG. 6d, FIG. 7d and FIG. 8d show a development of a weld bead 42.

After a complete run through the double cross, as shown in FIGS. 2a to FIG.

2e, the measuring means 26 is used to measure the keyhole 44, as shown in FIG. 3. In this case, the measuring beam 28 is guided to or jumps to a current position of the laser spot 50, that is, the point or position or location where the laser beam impinges on the conductor ends 18. In this case, a measuring beam 28 is emitted in a specific wavelength. At this position or location, the measuring means 22, in particular the OCT device, measures or determines a depth of the keyhole 44 as a second size parameter value. The measuring means 22 determines the keyhole depth by calculating the propagation time of the reflected signal 46, as schematically shown in FIG. 3. From this, height information of the component 14 in the z-direction can be determined. In other words, height information can be generated via the propagation time of the reflected radiation. This height information correlates, in particular, with an extension or height or depth of the molten pool 34 in the z-direction. Thus, a geometric change of the molten pool 34 can be detected. This can serve as an input variable for dimensioning the energy input.

The determination of the molten pool dimension is particularly necessary because there are cases in which not the entire wire cross-section is melted, for example in the case of a wide gap in which the melt flows into the gap. If the line distances are too large, the melt may possibly not reach the measuring lines M1 to M4 if the gap size is too large, so that too much energy, i.e., welding energy, would be introduced, although there is already a sufficient connection cross-section before the melt reaches the measuring lines.

After measuring with the measuring means 22, the molten pool dimension in the x- and y-directions, i.e., the first size parameter, and the location-related depth of the molten pool 34, i.e., the second size parameter, are known. From this, the melt volume and/or connection cross-section, i.e., the value, is calculated or determined by means of geometric observation. Alternatively, the melt volume can be used to determine the connection cross section. The melt volume and/or the connection cross-section can be determined by the measuring means 22 or the control means 24. Depending on the measuring progress and the melting progress, the increase in the melt volume is preferably determined and thus the connection cross-section. When a limit value is reached, the emission of the laser energy is stopped. In the measurement process, therefore, the measuring lines M1 to M4 can first be scanned and then the measuring beam 28 can be moved to the current position of the welding beam 26. These measuring steps can be repeated once or several times, in particular in this order.

In the case of differences in the geometric symmetrical position of the conductor ends 18 to be welded, an asymmetrical molten pool 34 is produced along the contact surface, since the energy is input symmetrically, for example via elliptical contours, and since the heat conduction leads to equal energy distribution into the two conductor ends 18a, 18b in the case of equal shares of irradiation.

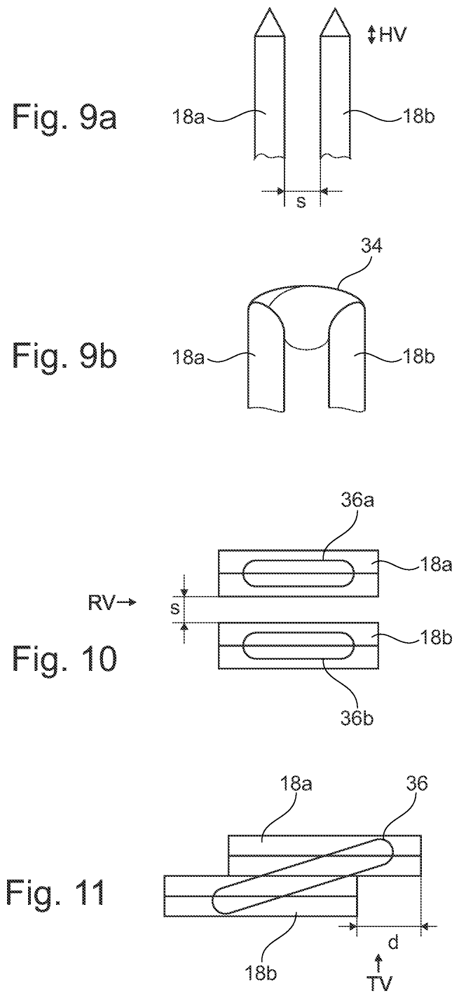

FIGS. 9a and 9b, FIG. 10 and FIG. 11 show three cases in which the irradiation location and the surface energy or the welding energy input are controlled depending on the wire cross-section or the cross-section of the conductor ends 18, 18a, 18b and the measurement signal (OCT) 46.

Case A is shown in FIGS. 9a and 9b. This case represents a height offset HV, significantly larger, as shown in FIG. 5 or FIG. 2a or FIG. 6a. Case B is shown in FIG. 10. This case represents a radial offset RV. The radial offset RV refers to the radial direction of the component 14 having a central axis. Case C is shown in FIG. 11. This case represents a tangential offset TV between the ends of the conductor.

Depending on the case (A-C), an implementation of the surface energy or welding energy input takes place according to the present geometric boundary conditions (A-C), so that a homogeneous welding bead 42 is produced or formed.

In case A of a height offset HV, the main part of the energy, i.e., the welding energy input, is applied to the higher conductor end or the higher pin, i.e., in this case the conductor end 18a, so that there is an identical height level of both welded conductor ends 18. During gap crossing, i.e., in particular a travel of the welding beam 26 from one conductor end 18a to the other conductor end 18b, the keyhole depth is measured and used as a measured variable, i.e., the second size parameter, for calculating the connection area or the connection cross-section.

In case B of a radial offset RV, two pin-related welding contours are involved to avoid energy input into the gap. That is, a first welding contour 36a is formed on the first conductor end 18a and a second welding contour 36b is formed on the second conductor end 18b by the welding means 16. The control means 24 can be arranged to control the welding means 16 in such a way that two welding beams are directed to the grouped conductor ends 18, one welding beam being assigned to one conductor end 18a, 18b of the grouped conductor ends 18 and the second welding beam being assigned to a further conductor end 18a, 18b of the grouped conductor ends 18. In particular, the welding means 16 may be arranged to direct a respective welding beam 26 sequentially or two welding beams simultaneously to the conductor ends. Particularly preferably, the welding beam 26 is first directed to the first conductor end 18a and then to the second conductor end 18b. The measurement contour in the form of a double cross can be maintained. Here, the point in time at which the two individual molten pools combine into a common molten pool 34 is to be tracked. In other words, a point in time can be recorded at which the two individual molten pools unite to form a molten pool 34, the first molten pool being assigned to the first conductor end 18a and the second molten pool being assigned to the second conductor end 18b. Concerning the measurement of the molten pool depth, in case B, the keyhole depth cannot be used as an evaluation variable because the keyhole is open downward, so that little or no signal response is returned. In this case, the information regarding the molten pool depth in the gap, i.e., the second size parameter value, is to be drawn from the molten pool depth on the pin surface, i.e., a surface of the conductor ends 18 or the respective conductor end.

In case C of the tangential offset TV, a distribution of the surface energy or welding energy input takes place according to the tangential offset present. If elliptical welding contours are used, the longitudinal axis must be rotated accordingly so that it intersects the centers of the individual pins or conductor ends. In particular, the elliptical welding contour runs around the center points of the respective conductor ends. The elliptical welding contour is arranged inclined to a longitudinal axis of the conductor ends at a predetermined angle. Accordingly, the contour of the double cross is to be set at an angle. The double cross can be adjusted in such a way that a shape or surface enclosed by the lines or the lines form a rhombic shape or contour. Analogous to case A), i.e., in the case of a height offset, the joint plane of the joining partners, i.e., in particular of the conductor ends, is used to evaluate the process zone depth.

The boundary conditions A to C can be present in different combinations to each other and thus the process can be combined according to the boundary conditions as described above.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 welding arrangement
12 welding device
14 component
16 welding means
18 conductor ends
18a first conductor end
18b second conductor end
20 pair of conductor ends
22 measuring means
24 control means
26 welding beam
28 measuring beam
30 gap
32 end zone
34 molten pool
36 contour
36a first contour
36b second contour
38 fusion ring
40 fusion blanket
42 bead
44 keyhole
46 signal
48 weld
50 laser spot
HV height offset
M1 first measuring lines
M2 second measuring lines
M3 third measuring lines
M4 fourth measuring lines
RV radial offset
TV tangential offset

1. A welding method for welding grouped conductor ends of a component for an electric machine by means of a welding device, comprising:
detecting a relative position of a first conductor end and a second conductor end of grouped conductor ends by position measurement using optical measurement methods, and subsequently, the steps of:
a) detecting a first size parameter of a molten pool formed during welding;
b) detecting a second size parameter of the molten pool formed during welding;
c) determining a value of the molten pool from the first size parameter, the second size parameter, and the relative position; and
d) controlling a welding energy input depending on the determined value of the molten pool.

2. The welding method according to claim 1, wherein step a) comprises at least one or more of the following steps:
a1) detecting the first size parameter by means of optical measurement methods;
a2) detecting the first size parameter by means of time-of-flight measurement of reflected radiation;
a3) performing optical coherence tomography;
a4) arranging a double cross relative to the grouped conductor ends, relative to an end region of the grouped conductor ends, and arranging lines of the double cross relative to each other, at a predetermined distance from each other;
a5) forming a double cross, which is assigned to an end region of the grouped conductor ends, larger than a welding contour;
a6) forming a double cross such that a measuring beam, which can be guided along the lines of the double cross, has at least one of predetermined jump paths or jump times;
a7) alternately guiding a measuring beam to different conductor ends;
a8) guiding a measuring beam to the grouped conductor ends in at least two dimensions;
a9) directing a measuring beam to a first end region of a first conductor end of the grouped conductor ends, and to a second end region of a second conductor end of the grouped conductor ends, in at least two dimensions;
a10) scanning a measuring beam along a double cross which is assigned to the grouped conductor ends, the double cross respectively comprising two lines which are arranged in x- and y-directions and are arranged at a predetermined distance from one another;
a11) detecting a lateral extension of the molten pool as a first size parameter, in a plane of the grouped conductor ends;
a12) detecting at least one input parameter, wherein as the at least one input parameter, at least one of
a cross-sectional area of an end region of the grouped conductor ends or at least one conductor end is detected,
a distance between the grouped conductor ends, prior to welding is detected,
a height offset between the grouped conductor ends is detected,
a tangential offset is detected, or
a radial offset is detected,
wherein the at least one input parameter is detected for determining the value.

3. The welding method according to claim 1, wherein step b) comprises at least one or more of the following steps:
b1) detecting the second size parameter by means of optical measurement methods;
b2) detecting the second size parameter by means of time-of-flight measurement of reflected radiation;
b3) performing optical coherence tomography;
b4) detecting the second size parameter at a position of a welding beam;
b5) guiding or directing a measuring beam to a current position of a welding beam;
b6) detecting a depth of a keyhole or a vapor capillary or a vapor channel, at a position of the welding beam;
b7) detecting a depth of a keyhole or a vapor capillary or a vapor channel at a position of the welding beam in a main extension direction of the grouped conductor ends;
b8) detecting a depth of a keyhole or a vapor capillary or a vapor channel in a beam direction of the welding beam;
b9) detecting a gap depth during gap crossing of at least one of a measuring beam or welding beam;
b10) detecting a molten pool depth;
b11) detecting a molten pool depth on a surface of at least one conductor end or of the grouped conductor ends, in particular at an end region of the grouped conductor ends;
b12) detecting a weld depth at a position of a welding beam;
b13) correlating a detected depth at a position of a welding beam with height information in a main extension direction of the grouped conductor ends;
b14) detecting at least one input parameter, wherein as the at least one input parameter, at least one of
a cross-sectional area of an end region of the grouped conductor ends or of at least one conductor end is detected,
a distance between the conductor ends prior to welding is detected,
a height offset between the conductor ends is detected,
a tangential offset is detected,
a radial offset is detected,
wherein the at least one input parameter is detected for determining the value.

4. The welding method according to claim 1, wherein step c) comprises at least one or more of the following steps:
c1) determining a molten pool dimension of the molten pool as a value of the molten pool;
c2) determining an increase in a melt volume as a value of the molten pool; or
c3) determining a connection cross-section of the grouped conductor ends as a value of the molten pool.

5. The welding method according to claim 1, wherein step d) comprises at least one or more of the following steps:
d1) directing a welding beam to the grouped conductor ends;
d2) guiding a welding beam, repeatedly, along a symmetrical contour;
d3) guiding a welding beam, repeatedly, along an elliptical contour;
d4) forming a fusion ring by means of a welding beam;
d5) forming a fusion blanket or a molten pool by means of a welding beam;
d6) forming a weld bead;
d7) starting the welding energy input to the grouped conductor ends;
d8) stopping the welding energy input to the grouped conductor ends;
d9) stopping the welding energy input to the grouped conductor ends when a determined value reaches a limit value;
d10) adjusting, by increasing or decreasing, the welding energy input to the grouped conductor ends;
d11) applying a predetermined higher welding energy input to the conductor end extending further or higher in a main extension direction of the grouped conductor ends, when there is a height offset between conductor ends in the grouped conductor ends;
d12) distributing a welding energy input according to a tangential offset between the conductor ends;
d13) directing two welding beams, either sequentially directing of one welding beam or simultaneous directing of two welding beams, to the grouped conductor ends, wherein one welding beam is assigned to one conductor end of the grouped conductor ends and another welding beam is assigned to another conductor end of the grouped conductor ends;
d14) detecting a point in time at which two individual molten pools combine into one molten pool, a first molten pool being assigned to a first conductor end and a second molten pool being assigned to the second conductor end;
d15) welding the conductor ends, at an end region or at an end face, in a parallel joint.

6. The welding method according to claim 1, wherein the detection of the relative position comprises at least one or more of the following steps:
6.1 position measuring by means of time-of-flight measurement of reflected radiation;
6.2 performing an optical coherence tomography;
6.3 alternately directing a measuring beam to different conductor end groups having at least one grouped conductor end;
6.4 measuring intervals or distances in at least two dimensions at a conductor end group;
6.5 measuring an interval or distance in a direction of an extension of conductor sections comprising conductor ends;
6.6 determining a distance between the conductor ends;
6.7 measuring a height offset between the conductor ends;
6.8 determining a cross-sectional area of an end regions of the grouped conductor ends or of at least one conductor end of the conductor ends;
6.9 determining a tangential offset between the conductor ends;
6.10 determining a radial offset between the conductor ends;
6.11 measuring at least one of a thickness, a width or a height of an end region at the conductor end group;
6.12 detecting at least one input parameter, wherein as the at least one input parameter
a cross-sectional area of an end region of the grouped conductor ends or of at least one conductor end is detected,
a distance between the conductor ends, prior to welding is detected,
a height offset between the conductor ends is detected,
a tangential offset is detected,
a radial offset is detected,
wherein the at least one input parameter is detected for determining the value.

7. The welding method according to claim 1, wherein
7.1 the welding method correlates at least one of the first size parameter, the second size parameter, an extension of the molten pool, a depth of a vapor channel or a vapor capillary at the position of a welding beam, at least one gap dimension or the value to at least one of corresponding sizes or corresponding data sets from preliminary experiments, or
7.2 a training data set for neural networks is formed, the training data set comprising
the first size parameter,
the second size parameter,
an extension of the molten pool,
a depth of a steam channel or a steam capillary at the position of the welding beam,
at least one gap dimension,
at least one of the value or data sets from previous experiments.

8. A welding device for welding grouped conductor ends of a component for an electrical machine, comprising:
a welding means for welding energy input to grouped conductor ends;
a measuring means for detecting a relative position of a first conductor end and a second conductor end of grouped conductor ends by position measurement using optical measurement methods, wherein
the measuring means is further adapted to detect a first size parameter of a molten pool formed during welding and a second size parameter of the molten pool formed during welding, wherein
the measuring means is further configured to determine a value of the molten pool from the first size parameter, the second size parameter and the relative position, and
a control means is configured to control a welding energy input to the grouped conductor ends to be welded depending on the determined value.

9. The welding device according to claim 8, wherein the measuring means is at least one of

9. 1 configured for evaluating a welding result; or
9.2 comprises a comparing means for comparing the value with a predetermined limit value.

10. The welding device according to claim 8, wherein the measuring means is selected from a group of measuring means comprising:

10.1 measuring means for detecting the first size parameter using optical measuring methods;

10.2 measuring means for detecting the first size parameter by means of time-of-flight measurement of reflected radiation;

10.3 measuring means for performing optical coherence tomography;

10.4 measuring means for arranging a double cross relative to an end region of the grouped conductor ends, and arranging lines of the double cross relative to each other at a predetermined distance;

10. 5 measuring means for forming a double cross, which is assigned to an end region of the grouped conductor ends, larger than a welding contour;

10.6 measuring means for forming a double cross such that a measuring beam, which is guidable along the lines of the double cross, has at least one of predetermined jump times or jump paths;

10.7 measuring means for alternately guiding a measuring beam to different conductor ends;

10.8 measuring means for directing a measuring beam onto the grouped conductor ends in at least two dimensions;

10.9 measuring means for directing a measuring beam to a first end region of a first conductor end of the grouped conductor ends, and to a second end region of a second conductor end of the grouped conductor ends in at least two dimensions;

10.10 measuring means for tracing a measuring beam along a double cross that is assigned to the grouped conductor ends, the double cross respectively comprising two lines which are arranged in the x- and y-directions and are arranged at a predetermined distance from one another;

10.11 measuring means for detecting a lateral extension of the molten pool, as a first size parameter, in a plane of the grouped conductor ends;

10.12 measuring means for detecting at least one input parameter, wherein
a cross-sectional area of an end region of the group of conductor ends or at least one conductor end,
a distance between the conductor ends, prior to welding,
a height offset between the conductor ends,
a tangential offset, or
a radial offset is detected as the at least one input parameter; or
10.13 a combination of one or more of the measuring means according to 10.1 to 10.12.

11. The welding device according to claim 8, wherein the measuring means is selected from a group of measuring means comprising:
11.1 measuring means for detecting the second size parameter using optical measuring methods;
11.2 measuring means for detecting the second size parameter by means of time-of-flight measurement of reflected radiation;
11.3 measuring means for performing optical coherence tomography;
11.4 measuring means for guiding a measuring beam to a position of a welding beam;
11.5 measuring means for detecting the second size parameter at a position of a welding beam;
11.6 measuring means for detecting a depth of a keyhole or a vapor capillary or a vapor channel at a position of a welding beam;
11.7 measuring means for detecting a depth of a keyhole or a vapor capillary or a vapor channel at a position of a welding beam in a main extension direction of the grouped conductor ends;
11.8 measuring means for detecting a gap depth during gap crossing of at least one of a measuring beam or a welding beam;
11.9 measuring means for detecting a molten pool depth;
11.10 measuring means for detecting a molten pool depth on a surface of at least one conductor end or of the grouped conductor ends;
11.11 measuring means for detecting at least one input parameter, wherein as the at least one input parameter
a cross-sectional area of an end region of the grouped conductor ends or of at least one conductor end is detected, p2 a distance between conductor ends of the grouped conductor ends, prior to welding is detected,
a height offset between the conductor ends is detected,
a tangential offset is detected,
a radial offset is detected,
wherein the at least one input parameter for determining the value is detected; or
11.12 a combination of one or more of the measuring means according to 11.1 to 11.11.

12. The welding device according to claim 8, wherein the measuring means is selected from a group of measuring means comprising:
12.1 a measuring means for determining a molten pool dimension of the molten pool as a value of the molten pool;
12.2 a measuring means for determining an increase in a melt volume as a value of the molten pool;
12.3 a measuring means for determining a connection cross-section of the grouped conductor ends as a value of the molten pool; or
12.4 a combination of one or more of the measuring means according to 12.1 to 12.3.

13. The welding device according to claim 8, wherein the measuring means is selected from a group of measuring means comprising:
13.1 measuring means for position measurement by means of time-of-flight measurement of reflected radiation;
13.2 measuring means for performing optical coherence tomography;
13.3 measuring means for alternately directing a measuring beam to different conductor end groups having has at least one grouped conductor end;
13.4 measuring means for measuring intervals or distances in at least two dimensions at a conductor end group;
13.5 measuring means for measuring an interval or a distance in a direction of an extension of conductor sections comprising the conductor end;
13.6 measuring means for determining a distance between the conductor ends;
13.7 measuring means for measuring a height offset between the conductor ends;
13.8 measuring means for determining a cross-sectional area of an end region of the grouped conductor ends or of at least one conductor end of the conductor ends;
13.9 measuring means for determining a tangential offset between the conductor ends;
13.10 measuring means for determining a radial offset between the conductor ends;
13.11 measuring means for measuring at least one of a thickness, a width or a height of the end region at the conductor end group; or
13.12 a combination of one or more of the measuring means according to 13.1 to 13.12.

14. The welding device according to claim 8, wherein the control means is configured to control the welding means for:
14.1 directing a welding beam to the grouped conductor ends;
14.2 guiding a welding beam along a symmetrical contour;
14.3 guiding a welding beam along an elliptical contour;
14.4 forming a fusion ring by means of a welding beam;
14.5 forming a fusion blanket by means of a welding beam;
14.6 forming a weld bead;
14.7 starting the welding energy input to the grouped conductor ends;
14.8 stopping the welding energy input to the grouped conductor ends;
14.9 stopping the welding energy input to the grouped conductor ends when the determined value reaches a limit value;
14.10 adjusting, by increasing or decreasing, the welding energy input to the grouped conductor ends;
14.11 applying a predetermined higher welding energy input to the conductor end extending further or higher in a main extension direction of the grouped conductor ends when there is a height offset between the conductor ends;
14.12 distributing a welding energy input according to a tangential offset between the conductor ends ; and/or
14.13 directing two welding beams to the grouped conductor ends, either sequentially or simultaneously, wherein one welding beam is assigned to one conductor end of the grouped conductor ends and another welding beam is assigned to another conductor end of the grouped conductor ends;
14.14 detecting a point in time at which two individual molten pools combine into one molten pool, a first molten pool being assigned to a first conductor end and a second molten pool being assigned to the second conductor end; or
14.15 welding the conductor ends, at an end region or at an end face, in a parallel joint.
15. A computer program product including machine-readable control instructions which, when loaded into a controller of a welding device for welding grouped conductor ends of a component for an electrical machine, the welding device comprising:
a welding means for welding energy input to grouped conductor ends;
a measuring means for detecting a relative position of a first conductor end and a second conductor end of grouped conductor ends by position measurement using optical measurement methods, wherein
the measuring means is further adapted to detect a first size parameter of a molten pool formed during welding and a second size parameter of the molten pool formed during welding, wherein
the measuring means is further configured to determine a value of the molten pool from the first size parameter, the second size parameter and the relative position, and
a control means is configured to control a welding energy input to the conductor ends to be welded depending on the determined value, cause the welding device to perform the welding process according claim 1.
